(19) United States
(12) Patent Application Publication
(10) Pub. No.: US 2026/0097339 A1
(43) Pub. Date: Apr. 9, 2026

(54) SMART FILTER CONTROL SYSTEM

(71) Applicant: GAMMON TECHNICAL PRODUCTS, INC., Manasquan, NJ (US)

(72) Inventor: James H. Gammon, Manasquan, NJ (US)

(21) Appl. No.: 19/350,826

(22) Filed: Oct. 6, 2025

Related U.S. Application Data
(60) Provisional application No. 63/703,231, filed on Oct. 4, 2024.

(51) Int. Cl. B01D 37/04; B64F 1/28; G05B 15/02; G05D 7/06

(52) U.S. Cl. CPC B01D 37/046; B01D 37/043; B64F 1/28; G05B 15/02; G05D 7/0623; B01D 2201/54

(57) ABSTRACT

A filter control system includes a plurality of filter vessel assemblies. The filter control system also includes a control center that has a user interface with access to a database, a computer programming unit, and a memory. The control center is in communication with the plurality of filter vessel assemblies.

### CROSS REFERENCE TO RELATED APPLICATIONS

### This application claims the benefit of US Provisional Application No 63703231 filed on October 4 2024 The entire disclosure of the above application is hereby incorporated herein by reference

### FIELD OF THE INVENTION

### The present invention is directed to a filter and more particularly to a filter for use in removing contamination from fluids

### BACKGROUND OF THE INVENTION

As known, a filter is employed in fluid flow systems to facilitate the removal of contamination from fluids. The filter vessel may include a housing with replaceable filtration elements that are configured to remove solid contaminants from a flow of fluid. Certain filters may also remove or separate different or discontinuous fluid flows from each other such as separating water from hydrocarbons, for example. For example, a medium to large airport fuel systems are employed to fuel aircrafts and/or other transportation means. The fuel systems include banks of filter separator vessels that are connected to pumps. A flow rate through the filter vessel varies with the demand for fuel. In an example, the filter vessel may be rated for 600 gallons per minute (gpm), but may see lower flow rates, depending on the demand.

The purpose of the filter vessels is to filter and remove dirt to minimize a pressure drop across the filter element from rising as the filter vessels become clogged with dirt. For example, the pressure at the inlet may be 140 psi and the pressure at the outlet may be 144 psi with a clean filter elements within the filter vessel. However, the filter elements in the filter vessel begin to clog the flow through the vessel. Once a differential pressure between the inlet and outlet reaches 15 psi then the filter elements are required to be changed or serviced. For example, if the inlet pressure is 140 psi and the outlet pressure is 125 psi, then the filter elements are required to be changed. Presently, most filter separator vessels do not have an automatic system to monitor this and prevent flow or to notify or alert a user. These flow systems are monitored manually.

The filters also remove water which can collect on the bottom or “sump” of the filter vessel. The vessels contain a control to automatically stop flow more than a desired amount of water collects at the bottom of the filter vessel. However, there is not typically a notification or alert device provided.

The filter vessels also have a air eliminating device to release any air in the fuel. This can take place for several reasons and may cause problems, including a fire inside the filter vessel, due to static electricity. There are currently no alarms or notifications.

Furthermore, the filter vessels may have pressure relief valves that only open if excessive pressure occurs. A filter vessel may also have a control valve on its outlet which typically serves two purposes. The first purpose is to limit the flow rate to below or equal to the maximum the vessel is rated. The second purpose od the control valve is to stop fluid flow if excessive water collects in the “sump. If the flow is not stopped, water may be released into the fuel which is undesirable.

Currently, automation in filter vessel systems has been limited to basic or general sensors remotely located from the filter in the fluid flow system. Some systems may not have notifications or alerts to indicate a flow event. Additionally, the filter systems do not allow for data collection, analysis, and predictive modification recommendations that can be realized in real time.

As such, it is desired for an improved filter control system configured to gather data, monitor, and evaluate the performance of a filter of a fluid flow system.

### SUMMARY OF THE INVENTION

Consistent and consonant with the present invention, an improved filter control system configured to gather data, monitor, and evaluate the performance of a filter of a fluid flow system has surprisingly been discovered.

According to an embodiment of the disclosure

### BRIEF DESCRIPTION OF THE DRAWINGS

The above advantages of the invention will become readily apparent to those skilled in the art from reading the following detailed description of an embodiment of the invention in the light of the accompanying drawings, in which:

FIG. 1 is a schematic view of a filter control system according to an embodiment of the disclosure;

FIG. 2 is a schematic view of a fuel delivery system of the filter control system of FIG. 1; and

FIG. 3 is an enlarged schematic view of a filter vessel assembly, highlighted by circle 3 of FIG. 2, and illustrating details of the filter vessel assembly.

### DETAILED DESCRIPTION OF THE PREFERRED EMBODIMENT

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

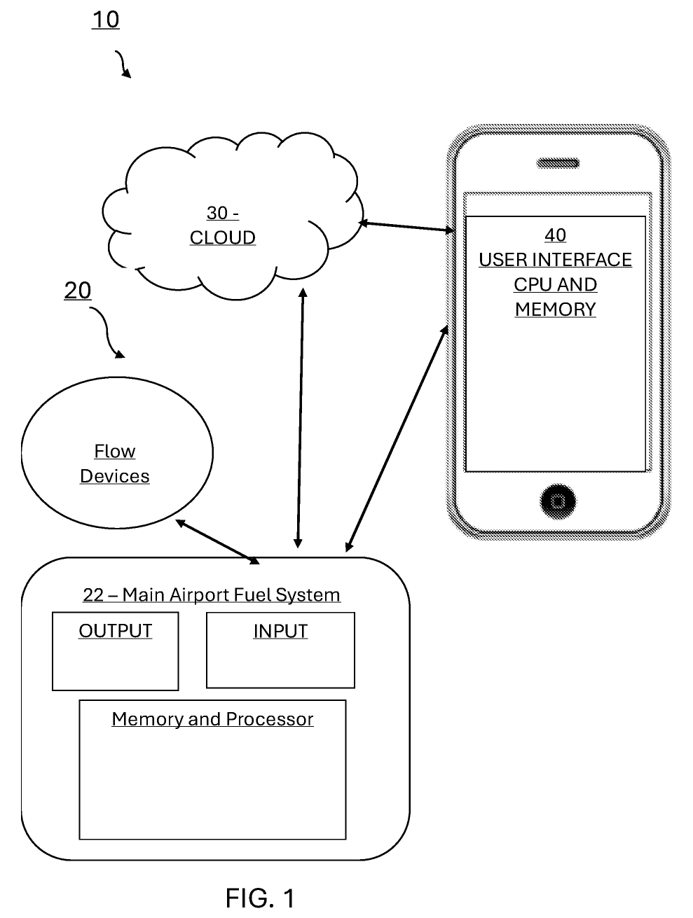

As shown in FIG. 1, a filter control system 10 includes a plurality of flow devices 20 of a fluid flow system. The flow devices 20 can be any fluid devices such as fluid regulators, relief valves, other flow valves, pressure gauges, temperature gauges, other gauges, filter vessels or elements, sensors, lasers, radars, monitors, floats, load cells, differential pressure transmitters, radar, or light devices, etc. The flow devices 20 communicate with a main airport fuel system control or control center 22 and the control center is in communication with a cloud 30.

The control center 22 may include hardware and/or software, a computer-readable medium or memory, and a communication system that conducts various operations for or with the respective vehicle flow devices 20. The operations can include but are not limited to providing information or output to a user interface 40 through a dashboard, screen, window, multiple computers or any other interface as desired, such as status of flow devices or flow status, receiving input from a user of the interface 40, and controlling functions or operations of the flow devices 20.

The control center 22 communicates, with wired communication or wireless communication through a network system, with the user interface 40 or computer including a CPU and memory, which, as shown, is a computer configured with a user interface 40 such as a mobile device. However, it is understood the user interface 40 can be configured as any one or more computers, communication devices, or mobile devices as desired and described herein. The control center 22 can be directly in communication with the user interface 40 or in communication with the user interface 40 via the cloud 30. The cloud 30 can be any virtual or remote network permitting users or systems to access and use computing resources, such as servers, storage, databases, networking, software, and more, over network systems such as the internet or any local area communication or wide area communication capability. The control center 22 can be located at a main location, such as at an airport for example, or the control center 22 is located at a remote facility from the airport where local data from the airport flow devices is collected and analyzed with a separate database through the user interface 40 offsite from the airport.

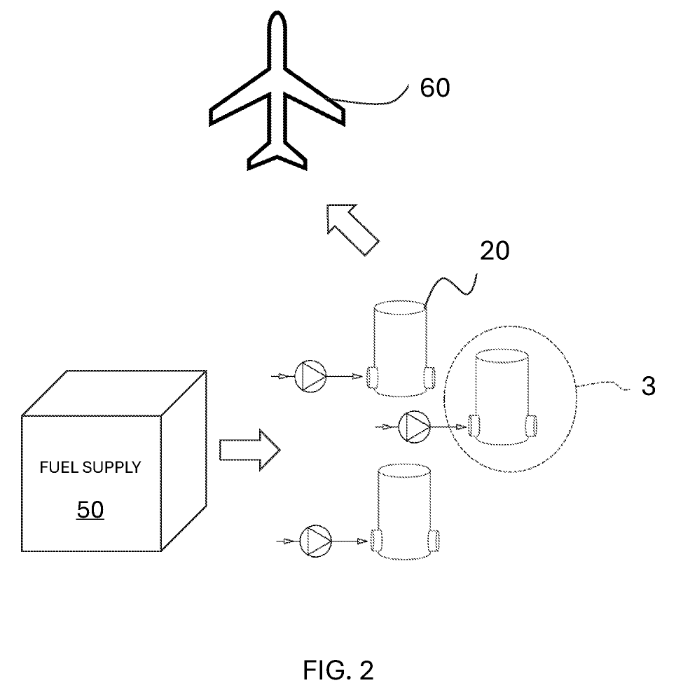

FIG. 2 illustrates an example of the filter control system 10 according to an embodiment of the disclosure. In the example, the filter control system 10 is configured for monitoring, determining, data collecting, and evaluating fluid flow variables and constants through the flow devices 20 of the fluid flow system. The flow devices 20 are configured as filter separator vessel assemblies and the fluid flow system is an airport fuel delivery system, herein designated as 100. The airport fuel delivery system 100 includes a fuel supply 50 fluidly connected upstream from the filter vessel assemblies 20 and a fuel delivery destination 60 such as an aircraft or aircraft adjacent compartment. The aircraft can be a airplane, jet, helicopter, or other flying vehicle. The aircraft adjacent compartment can be a fuel cabinet, refueling tank, cart, dispenser, or other compartment or carrier to delivering fuel to the delivery destination 60. It is understood, the delivery destination 60 can be any vehicle as desired without departing from the scope of the disclosure such as a car, bus, railcar, tank truck, ship/barge, etc. It is also understood the fuel delivery destination 60 can be any destination now known or later discovered in need of a flow of fuel. The plurality of filter assemblies 20 can be arranged parallel with each other or in series with each other or a combination thereof.

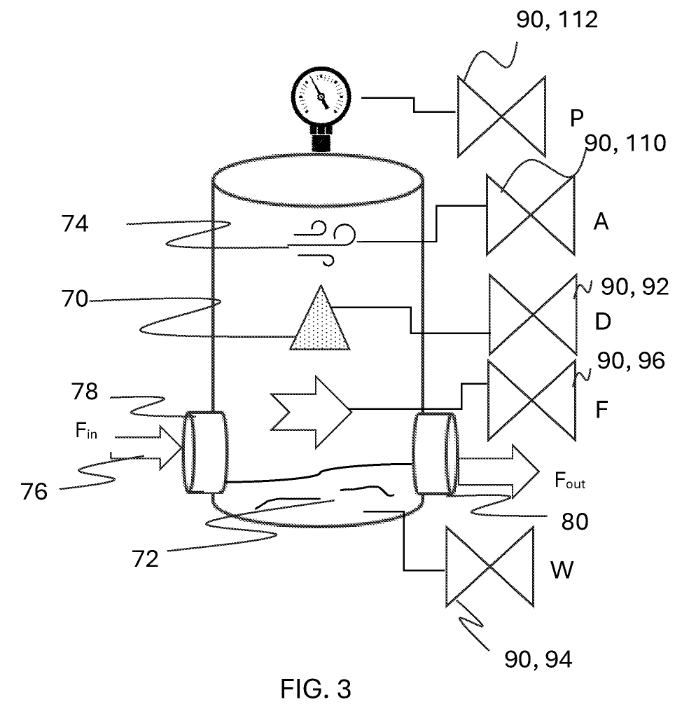

In FIG. 3, the filter vessel assembly 20 is configured to separate/remove debris 70, water 72, and/or air 74 from the fuel to decontaminate the fuel or minimize the total volume of debris 70, water 72, and/or air 74 from the fuel so the fuel is more concentrated and thus more desirable for the operation of the fuel delivery destination 60. A flow of a fluid, indicated by the arrows 76, such as fuel flows through the filter vessel assembly 20 at a flow rate. For example, the filter vessel assembly 20 may be rated for a flow rate of 600 gallons per minutes (GPM). A flow rate Fᵢₙ of the fluid at the inlet 78 of the filter vessel assembly 20 may be the same or different from a flow rate Fₒᵤₜ of the fluid at the outlet 80 of the filter vessel assembly 20. As the fluid flows through the filter vessel assembly 20, the debris 82, the air 84, and the water 86 are separated from the fluid.

The filter vessel assembly 20 includes several devices 90: a pressure drop device 92 (or debris indicator device), a water indicator device 94, a maximum flow device 96, an air eliminator device 110, and a pressure relief device 112. Each of the devices 90 may be valves, indicators, regulators, meters and/or a combination thereof.

For example, the pressure drop device 92 can be a combination of a pressure metering device recording a pressure Pᵢₙ at the inlet 78, a pressure metering device recording pressure Pₒᵤₜ at the outlet 80, and a valve to shut off flow of the fluid if the pressure drop, or difference, between the pressure Pᵢₙ at the inlet 78 exceeds the pressure Pₒᵤₜ at the outlet 80 by a desired amount. For example, if the pressure difference equals or exceeds 15 psi, the valve of the pressure drop device 92 shuts off the flow through the filter separator assembly 20. The pressure drop device 92 is in communication with the control center 22 so that the pressures P_{in,} Pₒᵤₜ can be collected, monitored, and recorded and the open or shut status of the valve can be recorded. Such a communication can better alert whether the filter vessel assembly 20 needs maintenance because it may be clogged with the debris 70, for example.

In another example, the water indicator device 94, can be a combination of a water level indicator and a shut off valve that shuts off flow of the fluid through the filter vessel assembly 20 if the water level reaches a certain height or amount. In the filter vessel assembly 20, the water 86 separated from the fuel collects in the bottom, or sump, of the filter vessel assembly 20. If the water 72 gets to a certain level, maintenance or a process may be required. The water indicator device 94 is in communication with the control center 22 so the water level data can be collected, monitored and recorded and the open or shut status of the valve can be recorded.

In another example, a maximum flow device 96 can include an indicator for indicating when the flow through the filter vessel assembly 20 and a shut off valve that shuts off the flow of the fluid through the filter vessel assembly 20 if the flow meets or exceeds a maximum flow rate, such as 600 GPM, for example. The maximum flow device 96 is in communication with the control center 22 so the flow rate data can be collected, monitored and recorded and the open or shut status of the valve can be recorded.

In another example, the air eliminator device 110 can include an air indicator and air eliminator valve to release air 74 in the fuel from the filter vessel assembly 20. The air eliminator device 110 is in communication with the control center 22 so if the air eliminator valve is actuated, the actuation can be collected, monitored and recorded and the open or shut status of the valve can be recorded and can alert those monitoring the system.

In yet another example, the pressure relief device 112, can include a meter and a valve that opens to relieve pressure only of the pressure within the filter vessel assembly 20 equals or exceeds an indicated pressure. The pressure relief device 112 is in communication with the control center 22 so if the pressure relief device is actuated, the actuation can be collected, monitored and recorded and the open or shut status of the valve can be recorded and can alert those monitoring the system that maintenance may be required.

All the data collected from the devices 90 are automatically stored in the control center 22 where calculations related to safety and efficiency are determined. The calculations can determine a life of the filter vessel assembly 20. The calculations can also determine, not only the amounts or values of pressures, flows, amounts, levels, etc. in real time, but also determine what the pressures, flows, amounts, levels, etc. will be in the future should one variable change. For example, if the flow increases through the filter vessel assembly 20 by a given amount, it may also reach a maximum pressure which will shut off the flow of the fluid by the pressure drop device 92, which is undesired. The control center 22 monitors and predicts what will occur in the future should a certain variable or characteristic fuel or of the filter vessel assembly 20 changes.

Advantageously, recording conditions and values of fuel through the filter vessel assembly 20 can be used for future predictions and for forensic study by experts. The system 10 determines if any condition is out of an acceptable range which will requiring immediate action.

The system 10 determines if a trend is occurring at a rate outside of the expected rate, indicating an unusual contamination or malfunction of the filter vessel assembly 20.

The system 10 monitors personnel actions, to ensure that periodic checks, tests, calibrations or filter element changes are done in a timely manner. Record these actions and test results. The system will automatically monitor pressure drop and correct it for changes in flow rate of the fuel. It is understood, other sensors or monitors can be included with the filter vessel assembly 20 to record other conditions unrelated to filtration but sensed by devices located at the filter vessel. This may include density, flash point, temperature, clarity, conductivity or other characteristics of the fluid. The system 10 provides access to this data from outside systems and operators through user interfaces and provide warnings when required. The system 10 can also communicate with other systems and controls, for example inventory control, environmental concerns (leakage) or fire sensing. The system 10 can record when filter elements of the filter vessel assembly 20 were last changed and how many gallons/liters have passed since the change. The system 10 compares past conditions with present conditions to detect change. Change in any aspect can signal a fuel quality change.

Advantageously, in a an example, the filter control system 10 is used in large airports on the filter vessel assemblies 20 that filter fuel into the airport storage tanks and filter it out into the underground “hydrant system” that delivers fuel to each gate underground.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A filter control system comprising:
a plurality of filter vessel assemblies; and
a control center having a user interface with access to a database, a computer programming unit, and a memory, the control center in communication with the plurality of filter vessel assmeblies.

2. The filter control system of claim 1, wherein at least one of the filter control assemblies includes a pressure drop device communicating with the control center.

3. The filter control system of claim 1, wherein at least one of the filter control assemblies includes a water indicator device communicating with the control center.

4. The filter control system of claim 1, wherein at least one of the filter control assemblies includes a maximum flow device communicating with the control center.

5. The filter control system of claim 1, wherein at least one of the filter control assemblies includes an air eliminator device communicating with the control center.

6. The filter control system of claim 1, wherein at least one of the filter control assemblies includes a pressure relief device communicating with the control center.

7. The filter control system of claim 1, wherein the filter control assemblies are filter control assemblies receiving a fluid and conveying the fluid to an airport delivery destination.

8. The filter control system of claim 1, wherein the filter control assemblies convey fuel therethrough.

9. The filter control system of claim 8, wherein the filter control assemblies separate at least one of a debris, a water, and an air from the fuel.

10. A filter control system comprising:
a filter vessel assembly receiving fuel from a fuel supply source and delivering the fuel to a fuel delivery destination, the filter vessel assembly having a plurality of devices included theroen; and
a control center having a user interface with access to a database, a computer programming unit, and a memory, the control center in communication the filter vessel assembly.

11. The filter control system of claim 10, wherein the plurality of devices includes a pressure drop device.

12. The filter control system of claim 11, wherein the plurality of devices includes a water indicator device.

13. The filter control system of claim 12, wherein the plurality of devices includes a maximum flow device.

14. The filter control system of claim 13, wherein the plurality of devices includes an air eliminator device.

15. The filter control system of claim 14, wherein the plurality of devices includes a pressure relief device.

16. The filter control system of claim 15, wherein the plurality of devices includes at least one of an indicator and a valve.

17. The filter control system of claim 16, wherein the control center receives data from the plurality devices to receive data from the indicator and whether the valve is open or shut.

18. The filter control system of claim 17, wherein the fuel delivery destination is an aircraft.

19. The filter control system of claim 17, wherein the fuel delivery destination is an aircraft adjacent compartment.

20. The filter control system of claim 17, wherein the control center receives information from the devices in real time and predicts future data of the filter vessel assembly.
